(19) United States
(12) Patent Application Publication
(10) Pub. No.: US 2012/0072999 A1
(43) Pub. Date: Mar. 22, 2012

(54) SYSTEM AND METHOD OF PROCESSING DOCUMENTS PROTECTED UNDER A DIGITAL RIGHTS MANAGEMENT SCHEME

(75) Inventors: Nancy Lynn Ishigo, Torrance, CA (US); Russell Robert Lear, Torrance, CA (US)

(73) Assignee: XEROX CORPORATION, Norwalk, CT (US)

(21) Appl. No.: 12/884,863

(22) Filed: Sep. 17, 2010

(51) Int. Cl. G06F 21/24; G06F 9/46; G06K 15/02

(52) U.S. Cl. 726/30; 358/1.14; 718/100

(57) ABSTRACT

A method of processing a document having digital rights management privileges may include receiving a document to be processed according a workflow. The received document may be associated with a license including one or more digital rights management (DRM) privileges. The method may include identifying one or more document production operations associated with the workflow and for each document production operation, determining whether the document production operation violates any of the DRM privileges associated with the document, in response to the document production operation violating one or more of the DRM privileges, assigning a first status to the document production operation, and in response to the document production operation not violating one or more of the DRM privileges, assigning a second status to the document production operation. The method may include automatically causing only document production operations to which the second status is assigned to be performed on the document.

### BACKGROUND

This disclosure relates to printing or otherwise processing secured documents, such as those protected under a Digital Rights Management scheme, using an automatic workflow in a document production environment.

Automatic workflows are not used to process secured documents. Rather, enforcement of rights associated with a secured document occur through the use of an approval workflow. An approval workflow requires manual processes to validate processing of a secured document. As such, a user who is familiar with the rights associated with a secured document must decide, on an operation by operation basis, whether a particular use of the document is allowed based on its rights. For example, a document protected under a Digital Rights Management scheme require the author or someone who is familiar with the document and its rights to decide, whether the document can be printed or otherwise processed by a document production environment pursuant to the document's associated rights. This makes processing a secured document an inefficient and tedious process.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a method of processing a document having digital rights management privileges may include receiving, by a computing device, a document to be processed according a workflow. The received document may be associated with a license including one or more digital rights management (DRM) privileges. The method may include identifying, by the computing device, one or more document production operations associated with the workflow and for each document production operation, determining, by the computing device, whether the document production operation violates any of the DRM privileges associated with the document, in response to the document production operation violating one or more of the DRM privileges, assigning, by the computing device, a first status to the document production operation, and in response to the document production operation not violating one or more of the DRM privileges, assigning, by the computing device, a second status to the document production operation. The method may include automatically causing, by the computing device, only document production operations to which the second status is assigned to be performed on the document.

In an embodiment, a system for processing a document having digital rights management privileges may include a computing device and a computer-readable storage medium in communication with the computing device. The computer-readable storage medium may include one or more programming instructions for receiving a document to be processed according to a workflow. The received document may be associated with a license comprising one or more digital rights management (DRM) privileges. The computer-readable storage medium may include one or more programming instructions for identifying one or more document production operations associated with the workflow, and for each document production operation, determining whether the document production operation violates any of the DRM privileges associated with the document, in response to the document production operation violating one or more of the DRM privileges, assigning a first status to the document production operation, and in response to the document production operation not violating one or more of the DRM privileges, assigning a second status to the document production operation. The computer-readable storage medium may include one or more programming instructions for automatically causing only document production operations to which the first status is not assigned to be performed on the document.

### BRIEF DESCRIPTION OF THE DRAWINGS

FIG. 1 illustrates an exemplary document production environment according to an embodiment.

FIG. 2 illustrates an exemplary method of automatically processing a document according to an embodiment.

FIG. 3 depicts a block diagram of exemplary internal hardware that may be used to contain or implement program instructions according to an embodiment.

### DETAILED DESCRIPTION

The following terms shall have, for purposes of this application, the respective meanings set forth below:

A “document” refers to a logical unit of work that is processed in a document production environment. A document may include text, images and/or the like, and may be embodied in an electronic format or a physical substrate.

A “Digital Rights Management (DRM) document” refers to an encrypted document having an associated DRM license.

A “printing device” refers to an electronic apparatus that is capable of receiving commands, printing text, vector graphics and/or images on a substrate, and optionally, also scanning or otherwise processing a document. Printing devices may include, but are not limited to, network printers, production printers, copiers, facsimile machines and/or other devices using ink or toner.

A “document production operation” refers to a print-related function that is performed on a document during document production. A document production operation may include prepress and/or processing operations.

A “prepress operation” is a document production operation that is performed on a document to alter the content, formatting or dimension of the document before the document is processed by, for example, sending the document to a production or network printer. Exemplary prepress operations may include performing imposition, performing color management operations, cropping, resizing and/or the like.

A “processing operation” is an operation that is performed during the processing of a document, such as printing, emailing, scanning, faxing, binding, collating and/or the like.

A “workflow” refers to an ordered sequence of operations designed to enable repeatable processing of documents. A workflow may include operations that transform a document in some manner and/or result in the display, transmission or conversion into physical form of the document.

A “workflow system” is a computer system that implements and/or performs one or more workflows. A workflow system may include one or more computing or other devices needed to implement a workflow. For example, a workflow system in a print environment may perform one or more workflows on a document or other print job. A workflow in a print environment may include one or more computing devices and/or printing devices needed to perform a workflow.

“Digital Rights Management privileges” or “DRM privileges” are access control rights that impose limitations on how digital content can be used, accessed, modified and/or the like. DRM privileges may include limitations as to who can access the document, how many copies of the document can be printed, who is able to modify the document and/or the like.

A “Digital Rights Management license” or “DRM license” is an electronic file that describes the DRM privileges associated with a DRM document. For example, a DRM license may describe DRM privileges to a DRM document's content, identify the users or devices to whom the rights are granted and/or identify the conditions under which the rights are granted.

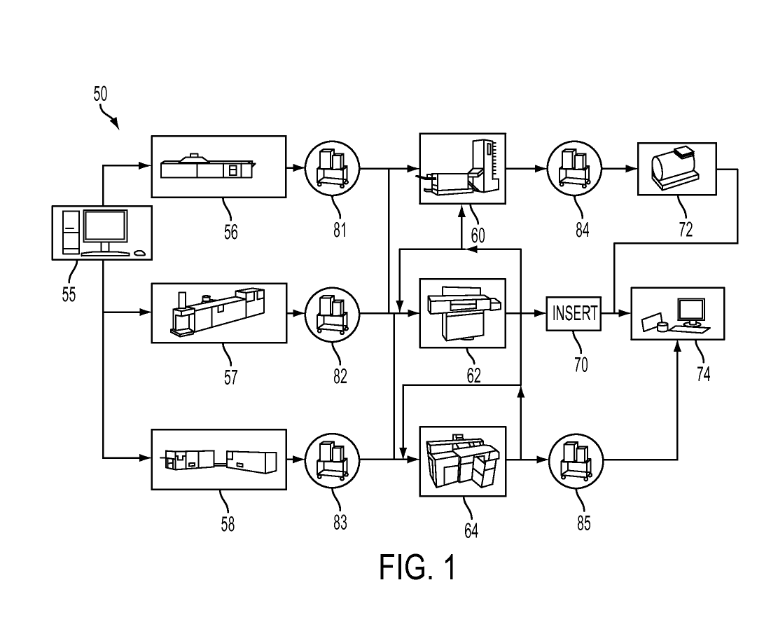

FIG. 1 shows an example of a document production environment 50. A document may enter the document production environment manually or electronically and be collected at an electronic submission system 55 such as a computing device and/or scanner. Documents are sorted and batched at the submission system or another location before being delivered to one or more print engines such as a color printer 56, black-and-white printer 57 and/or a continuous feed printer 58. Documents may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, documents may move to a postage metering station 72 and/or shipping station 74. Documents may move from one location to another in the document production environment by automatic delivery or manual delivery such as by hand or by one or more paper carts 81-85.

Workflows may enable automatic performance of document production operations to one or more documents. For example, a large number of documents may be passed through a sequence of document production operations without human intervention if the documents each require similar processing. In an embodiment, a user may select one or more workflows from a plurality of predefined workflows to perform on one or more documents. A user may also create one or more new workflows to perform on one or more documents.

In an embodiment, a document to be processed according to a workflow may be protected by its associated DRM privileges. Such a document may be referred to as a DRM document. A DRM document may have an associated license. A license is an electronic file that describes the DRM privileges associated with a DRM document. For example, a license may describe the rights and/or privileges to the DRM document's content, identify the users or devices to whom the rights are granted and/or identify the conditions under which the rights are granted. Exemplary DRM privileges may include a time before which and/or after which a DRM document cannot be printed, a number of copies of a DRM document that can be printed at one time, a total number of copies of a DRM document that can be printed, a user or users who can print a DRM document, a users or users who can view a DRM document and/or the like.

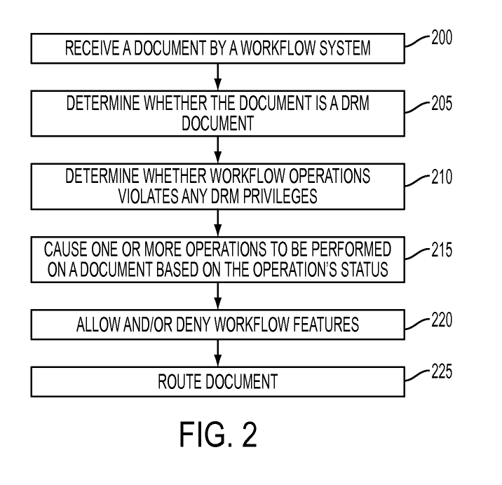

FIG. 2 illustrates an exemplary method of automatically processing a document according to an embodiment. As illustrated by FIG. 2, a document may be received 200 by a workflow system. In an embodiment, a document may be received 200 by a workflow system from a computing device, a printing device and/or the like via an electronic transmission, such as via a network. The workflow system may determine 205 whether a document is a DRM document. For example, the workflow system may determine 205 whether a document is a DRM document by checking whether it has an associated license.

In response to a document being identified as a DRM document, the workflow system may determine 210 whether one or more workflow operations violate one or more of the DRM privileges set forth in the document's license. A workflow operation is a document production operation that is performed as part of a workflow. For example, a certain workflow may perform the following sequence of document production operations: imposition, crop, print. In this example, each of these document production operations is a workflow operation.

In an embodiment, a workflow system may determine 210 whether one or more workflow operations violate one or more of the DRM privileges set forth in the document's license by comparing each workflow operation to each DRM privilege in the document's license to determine whether a workflow operation violates any of the DRM privileges. In an embodiment, a computing device may use a local or remote source of information, including, but not limited to a database and/or a lookup table, to compare a workflow operation to a DRM privilege. For example, a computing device may query a remote clearinghouse to obtain a number of copies of a document that have been printed to date. The computing device may compare this number with an allowed maximum number of copies that can be printed as permitted by the document's DRM license. For each workflow operation to be performed on a document, the computing device may use local and/or remote information about a document's DRM history to determine whether the workflow operation is an allowed workflow operation for each of the DRM privileges associated with the document. If the workflow operation is listed as an allowed workflow operation, the workflow operation does not violate the DRM privilege. If the workflow operation is not listed as an allowed operation, the workflow operation violates the DRM privilege. If the workflow system does not have information on how to validate a specific workflow operation against one or more DRM privileges, the workflow operation may be assumed to violate the DRM privilege.

Alternatively, a database or lookup table may store one or more DRM privileges and one or more prohibited workflow operations for each DRM privilege. For each workflow operation to be performed on a document, the computing device may determine whether the workflow operation is listed in the database as a prohibited workflow operation for each of the DRM privileges associated with the document. If the workflow operation is listed as a prohibited workflow operation for a DRM privilege, the workflow operation violates the DRM privilege. If the workflow operation is not listed as a prohibited workflow operation for a DRM privilege, the workflow operation does not violate the DRM privilege.

For example, workflow operations to be performed on a document may include cropping and printing. Exemplary DRM privileges associated with the document may include a prohibition on modifications to the document and a prohibition on transmitting the document via electronic mail. Table 1 illustrates exemplary database or lookup table entries for these two DRM privileges.

TABLE 1

| | Prohibited Workflow |
|---|---|
| DRM Privilege | Operations |
| No modifications | Imposition |
| | Color enhancement |
| | Image rotation |
| | Cropping |
| No transmission via electronic | Emailing |
| mail | |

In an embodiment, a computing device may determine whether the cropping workflow operation is identified as a prohibited workflow operation for either of the DRM privileges. Because cropping is listed as a prohibited workflow operation for the DRM privilege that prohibits modifications, the cropping workflow operation violates the no modification DRM privilege. The printing workflow operation is not listed as a prohibited workflow operation for the no modifications DRM privilege, so it does not violate this DRM privilege. Likewise, the printing workflow operation is not listed as a prohibited workflow operation for the no electronic mail transmission DRM privilege, so it does not violate this DRM privilege.

In an embodiment, a workflow system may determine a status for one or more of the workflow operations. For example, if a requested workflow operation violates one or more of the DRM privileges, the operation may be assigned a “deny” status. If a requested workflow operation does not violate any of the DRM privileges, the operation may be assigned an “allow” status. If it is unclear whether an operation violates a DRM privilege, the operation may be assigned a “deny” status. In an embodiment, a notification may be generated if any of the operations have a “deny” status. For example, an email may be sent to a document's creator notifying the creator of the operations that have a “deny” status. Additional and/or alternate statuses may be used within the scope of this disclosure.

In an embodiment, a computing device may automatically cause 215 one or more document production operations to be performed on a document based on each document production operation's associated status. In an embodiment, the computing device may cause another computing device, a printing device and/or the like to perform one or more document production operations on a document. In an embodiment, the computing device may perform one or more document production operations on a document. For example, the computing device may automatically cause 215 an operation having an “allow” status to be performed on a document. As another example, the computing device may cause 215 one or more document production operations having a “deny” status to not be performed on a document.

In an embodiment, the computing device may only cause 215 document production operations that have a certain status to be performed on a document. For example, the computing device may only cause 215 document production operations that have an “allow” status to be performed on a document. In an embodiment, a computing device may not cause 215 any document production operations to be performed on a document if one or more operations in the workflow have a certain status. For example, a computing device may not cause 215 any document production operations that have a “deny” status to be performed on a document. In an embodiment, a workflow may perform operations until it encounters an operation having a “deny” status. At this time, the workflow may notify the document's creator that an operation has a “deny” status.

In an embodiment, a workflow system may allow or deny 220 certain workflow operations or features based on the DRM privileges set forth in the license associated with the document. For example, DRM privileges associated with a DRM document may allow a certain user to print the DRM document, but provides that the contents of the DRM document are not otherwise to be divulged. In response, the workflow system may deny an option to see a job preview, an option to save files derived from the DRM document, an option to attach a derived file to email notifications, an option to print to unsecured print destinations and/or the like. In an embodiment, a computing device may allow or deny 220 workflow options, such as print quantity, imposition settings and/or the like, based on the document's DRM privileges.

In an embodiment, a workflow system may route 225 one or more documents based on the documents associated rights. In an embodiment, a computing device may route 225 one or more documents based on a status associated with one or more operations. For example, a workflow system may restrict the export of a document unless the export destination honors the DRM privileges set forth in the document's license. As another example, a workflow system may restrict transmission of a document for which the associated license rights prohibit such transmission.

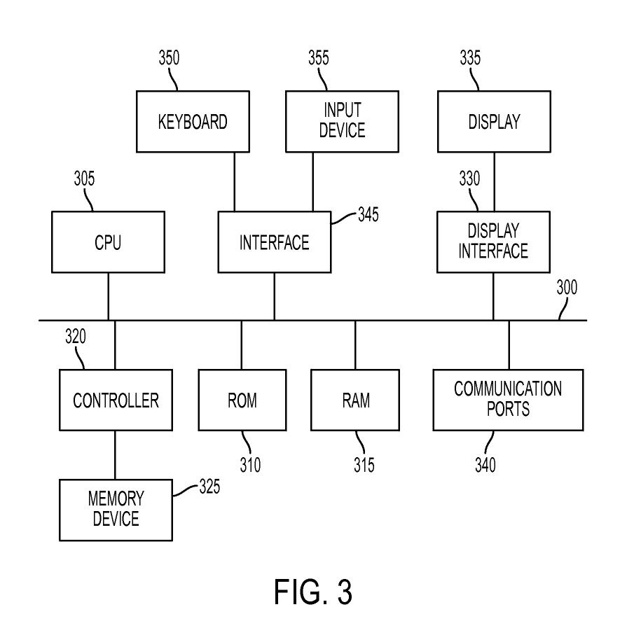

FIG. 3 depicts a block diagram of exemplary internal hardware for a computing device that may be used to contain or implement program instructions according to an embodiment. A bus 300 serves as the main information highway interconnecting the other illustrated components of the hardware. CPU 305 is the central processing unit of the system, performing calculations and logic operations required to execute a program. Read only memory (ROM) 310 and random access memory (RAM) 315 constitute exemplary memory devices.

A controller 320 interfaces with one or more optional memory devices 325 to the system bus 300. These memory devices 325 may include, for example, an external or internal DVD drive, a CD ROM drive, a hard drive, flash memory, a USB drive or the like. As indicated previously, these various drives and controllers are optional devices.

Program instructions may be stored in the ROM 310 and/or the RAM 315. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 330 may permit information from the bus 300 to be displayed on the display 335 in audio, visual, graphic or alphanumeric format. Communication with external devices may occur using various communication ports 340. An exemplary communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of processing a document having digital rights management privileges, the method comprising:
receiving, by a computing device, a document to be processed according a workflow, wherein the received document is associated with a license comprising one or more digital rights management (DRM) privileges;
identifying, by the computing device, one or more document production operations associated with the workflow;
for each document production operation:
determining, by the computing device, whether the document production operation violates any of the DRM privileges associated with the document,
in response to the document production operation violating one or more of the DRM privileges, assigning, by the computing device, a first status to the document production operation, and
in response to the document production operation not violating one or more of the DRM privileges, assigning, by the computing device, a second status to the document production operation; and
automatically causing, by the computing device, only document production operations to which the second status is assigned to be performed on the document.

2. The method of claim 1, wherein identifying one or more document production operations comprises identifying one or more prepress operations.

3. The method of claim 1, wherein identifying one or more document production operations comprises identifying one or more processing operations.

4. The method of claim 1, further comprising:
sending a notification to a creator of the document, wherein the notification identifies the operations having the first status.

5. The method of claim 1, wherein automatically causing only document production operations to which the second status is assigned to be performed on the document comprises allowing one or more workflow options based on the status associated with each operation.

6. The method of claim 1, further comprising:
denying one or more workflow options based on the status associated with each operation.

7. The method of claim 6, wherein denying one or more workflow options comprises denying one or more of the following options in response to the operation having the first status:
a job preview;
saving one or more files derived from the document;
attaching a file derived from the document to an email notification; and
printing the document to an unsecured print destination.

8. The method of claim 6, wherein denying one or more workflow options comprises denying one or more prepress operations.

9. The method of claim 6, wherein denying one or more workflow options comprises denying one or more processing operations.

10. The method of claim 1, wherein automatically causing only document production operations to which the second status is assigned to be performed on the document comprises restricting the routing of the document based on the status associated with one or more document production operations.

11. The method of claim 1, wherein determining whether the document production operation violates any of the DRM privileges associated with the document comprises:
comparing the document production operation to each DRM privilege associated with the document to determine whether the document production operation violates the DRM privilege.

12. The method of claim 1, wherein determining whether the document production operation violates any of the DRM privileges associated with the document comprises for each DRM privilege associated with the document:
determining whether the document production operation is identified as an allowed operation associated with the DRM privilege; and
in response to the document production operation not being identified as an allowed operation, identifying the document production operation as violating the DRM privilege.

13. The method of claim 1, wherein determining whether the document production operation violates any of the DRM privileges associated with the document comprises for each DRM privilege associated with the document:
determining whether the document production operation is identified as a prohibited operation associated with the DRM privilege; and
in response to the document production operation being identified as a prohibited operation, identifying the document production operation as violating the DRM privilege.

14. A system for processing a document having digital rights management privileges, the system comprising:
a computing device; and
a computer-readable storage medium in communication with the computing device, wherein the computer-readable storage medium comprises one or more programming instructions for:
receiving a document to be processed according to a workflow, wherein the received document is associated with a license comprising one or more digital rights management (DRM) privileges,
identifying one or more document production operations associated with the workflow, for each document production operation:
determining whether the document production operation violates any of the DRM privileges associated with the document,
in response to the document production operation violating one or more of the DRM privileges, assigning a first status to the document production operation, and
in response to the document production operation not violating one or more of the DRM privileges, assigning a second status to the document production operation, and
automatically causing only document production operations to which the first status is not assigned to be performed on the document.

15. The system of claim 14, wherein the one or more programming instructions for identifying one or more document production operations comprise one or more programming instructions for identifying one or more prepress operations.

16. The system of claim 14, wherein the one or more programming instructions for identifying one or more document production operations comprise one or more programming instructions for identifying one or more processing operations.

17. The system of claim 14, wherein the computer-readable storage medium further comprises one or more programming instructions for sending a notification to a creator of the document, wherein the notification identifies the document production operations having the first status.

18. The system of claim 14, wherein the one or more programming instructions for automatically causing only document production operations to which the second status is assigned to be performed on the document comprise one or more programming instructions for allowing one or more workflow options based on the status associated with each document production operation.

19. The system of claim 14, wherein the computer-readable storage medium further comprises one or more programming instructions for denying one or more workflow options based on the status associated with each document production operation.

20. The system of claim 19, wherein the one or more programming instructions for denying one or more workflow options comprise one or more programming instructions for denying one or more of the following options in response to the document production operation having the first status:
a job preview;
saving one or more files derived from the document;
attaching a file derived from the document to an email notification; and
printing the document to an unsecured print destination.

21. The system of claim 19, wherein the one or more programming instructions for denying one or more workflow options comprise one or more programming instructions for denying one or more prepress operations.

22. The system of claim 19, wherein the one or more programming instructions for denying one or more workflow options comprise one or more programming instructions for denying one or more processing operations.

23. The system of claim 14, wherein the one or more programming instructions for automatically causing only operations to which the second status is assigned to be performed on the document comprise one or more programming instructions for restricting the routing of the document based on the status associated with one or more operations.

24. The method of claim 23, wherein the one or more programming instructions for restricting the routing of the document comprise one or more programming instructions for preventing the document from being transmitted to a destination.
